(19) United States
(12) Patent Application Publication
(10) Pub. No.: US 2014/0185273 A1
(43) Pub. Date: Jul. 3, 2014

(54) Backlight Module for Light Field Adjustment

(71) Applicant: AU Optronics Corporation, Hsin-Chu (TW)

(72) Inventors: Zong-Huei Tsai, Hsin-Chu (TW); Chiung-Han Wang, Hsin-Chu (TW)

(73) Assignee: AU Optronics Corporation, Hsin-Chu (TW)

(21) Appl. No.: 14/033,706

(22) Filed: Sep. 23, 2013

(30) Foreign Application Priority Data
Dec. 27, 2012 (TW) 101150481

(51) Int. Cl. F21V 5/00

(52) U.S. Cl. CPC F21V 5/004
USPC 362/97.1

(57) ABSTRACT

A backlight module for light field adjustment includes a light source module, an optical structure layer, a first prism film, and a second prism film. The light source module has a light exit surface, and the light exit surface has a normal direction. The optical structure layer is disposed on the light exit surface and has a plurality of microstructures convex toward the light exit surface, wherein the microstructures guide light generated from the light exit surface away from the normal direction. The first prism film is disposed on one side of the optical structure layer opposite to the light source module and has a plurality of first prisms extending along a first direction, wherein the first prisms converge light leaving from the optical structure layer toward the normal direction on a cross section vertical to the first direction.

### BACKGROUND OF THE INVENTION

1. Field of the Invention

The present invention generally relates to a backlight module for light field adjustment. Particularly, the present invention relates to a backlight module that can increase light output efficiency and adjust light field.

2. Description of the Prior Art

As technology is continuously developed, applications of display devices in all kind of fields can be seen everywhere in daily life. In practical applications, display devices display image through light generated by a backlight module. For example, backlight modules include edge type backlight modules and direct type backlight modules, and these two types of backlight modules are commonly used in current display devices as the lighting module.

Particularly, please refer to FIG. 1 of a schematic view of light entering the prism in the conventional backlight module. As shown in FIG. 1, the conventional backlight module uses a light source 3 to emit light and a diffuser 4 to adjust the direction of light. For example, light 5 enters the prism 6 in a direction parallel to the normal direction 7 (i.e. the forward direction). However, in practical situations, light 5 is readily totally reflected at the light exit surface 6A of the prism 6 such that light 5 is not easy to be emitted out of the prism 6. In other words, light having an incident direction parallel to the normal direction 7 will have poor light output efficiency.

In addition, light 5A enters the prism in a direction deviated from the normal direction 7 by at least less than about viewing angle 25 degrees and has total reflections at the first time contacting the light exit surface 6A and refractions at the second time contacting the light exit surface 6A. However, in practical situations, light 5A is emitted out of the light exit surface 6A in a direction deviated from the normal direction 7 by larger than about viewing angle 25 degrees, resulting in loss of most light as well as bad influence on light output efficiency.

### SUMMARY OF THE INVENTION

It is an object of the present invention to provide a backlight module, which can improve light output efficiency and adjust light field.

In one aspect, the present invention provides a backlight module, which utilizes the optical structure layer to improve the light output efficiency.

In another aspect, the present invention provides a backlight module, which can adjust the light field by changing the advancing direction of light.

In one embodiment, the backlight module of the present invention includes a light source module, an optical structure layer, a first prism film, and a second prism film. The light source module has a light exit surface, wherein the light exit surface has a normal direction. The optical structure layer is disposed on the light exit surface and has a plurality of microstructures convex toward the light exit surface. The microstructures guide light that leaves the light exit surface away from the normal direction. The first prism film is disposed on one side of the optical structure layer opposite to the light source module and has a plurality of first prisms extending along a first direction. The first prisms converge light leaving from the optical structure layer toward the normal direction on a cross section vertical to the first direction.

In another embodiment, the backlight module of the present invention includes a light source module, an optical structure layer, a first prism film, and a second prism film. The light source module has a light exit surface, wherein the light exit surface has a normal direction. The light source module emits light to form a first light field and the first light field generates an intensity covering range. The optical structure layer is disposed on the light exit surface, wherein the optical structure layer changes the first light field to form a second light field. In the second light field, the intensity covering range radially extends outward with intensity gradually reduced toward a center to form an intensity ring.

In addition, the first prism film is disposed on one side of the optical structure layer opposite to the light source module, wherein the first prism film has a plurality of first prisms extending along a first direction. The first prisms change the second light field to form a third light field. In the third light field, the intensity ring is converged toward the normal direction on a cross section vertical to the first direction. In the embodiment, the second prism film is disposed on one side of the first prism film opposite to the light source module and changes the third light field to form a fourth light field. In the fourth light field, the intensity ring is converged toward the normal direction on a cross section parallel to the first direction.

In comparison with prior arts, the backlight module of the present invention utilizes the optical structure layer to change the advancing direction of light that prevents light from entering the first prism film along the normal direction (i.e. the forward direction) so as to prevent the total reflection. In addition, the backlight module of another embodiment of the present invention utilizes the optical structure layer to adjust the light field that changes the distribution of light at different emission angles so as to improve the light output efficiency.

The above and other objects, features and advantages of the present invention will be more clearly understood from the following detailed description taken in conjunction with the accompanying drawings.

### BRIEF DESCRIPTION OF THE DRAWINGS

FIG. 1 is a schematic view of light entering the prism in the conventional backlight module;

FIG. 2A is a schematic view of the embodiment of the backlight module of the present invention;

FIG. 2B is a side view of the embodiment of the backlight module of the present invention;

FIG. 3A is a graph showing the relative relation among the measured full width at half maximum of the light field, the vertex angle of microstructures, and the relative intensity at the front view angle of the embodiment of the backlight module of the present invention;

FIG. 3B is a graph showing the relative relation among the measured full width at half maximum of the light field, the vertex angle of microstructures, and the relative intensity at the front view angle of another embodiment of the backlight module of the present invention;

FIG. 3C is a graph showing the relative relation among the measured full width at half maximum of the light field, the vertex angle of microstructures, and the relative intensity at the front view angle of the embodiment of the backlight module of the present invention;

FIG. 4A is a graph showing the distribution of the first light field of the embodiment of the present invention;

FIG. 4B is a graph showing the distribution of the second light field of the embodiment of the present invention;

FIG. 4C is a graph showing the distribution of the third light field of the embodiment of the present invention;

FIG. 4D is a graph showing the distribution of the fourth light field of the embodiment of the present invention;

FIG. 5 is a schematic view of another embodiment of the backlight module of the present invention;

FIG. 6A is a graph showing the distribution of the first light field of another embodiment of the present invention;

FIG. 6B is a graph showing the distribution of the second light field of another embodiment of the present invention;

FIG. 6C is a graph showing the distribution of the third light field of another embodiment of the present invention; and

FIG. 6D is a graph showing the distribution of the fourth light field of another embodiment of the present invention.

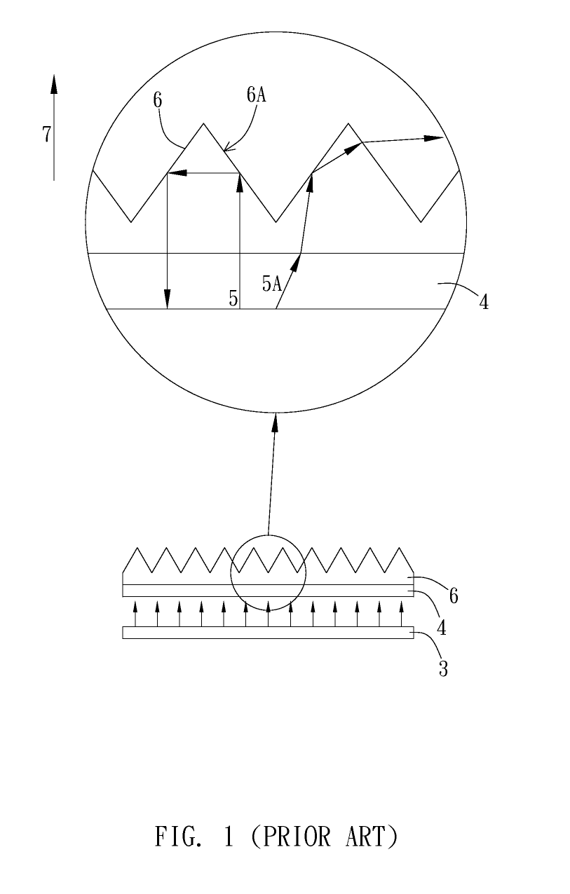

### DETAILED DESCRIPTION OF THE PREFERRED EMBODIMENT

According to one embodiment, the present invention provides a backlight module, which can adjust the light field to improve the light output efficiency. In the embodiment, the backlight module can be a direct type backlight module. In addition, the backlight module is preferably used in liquid crystal displays and also can be used in other types of display devices utilizing a backlight module.

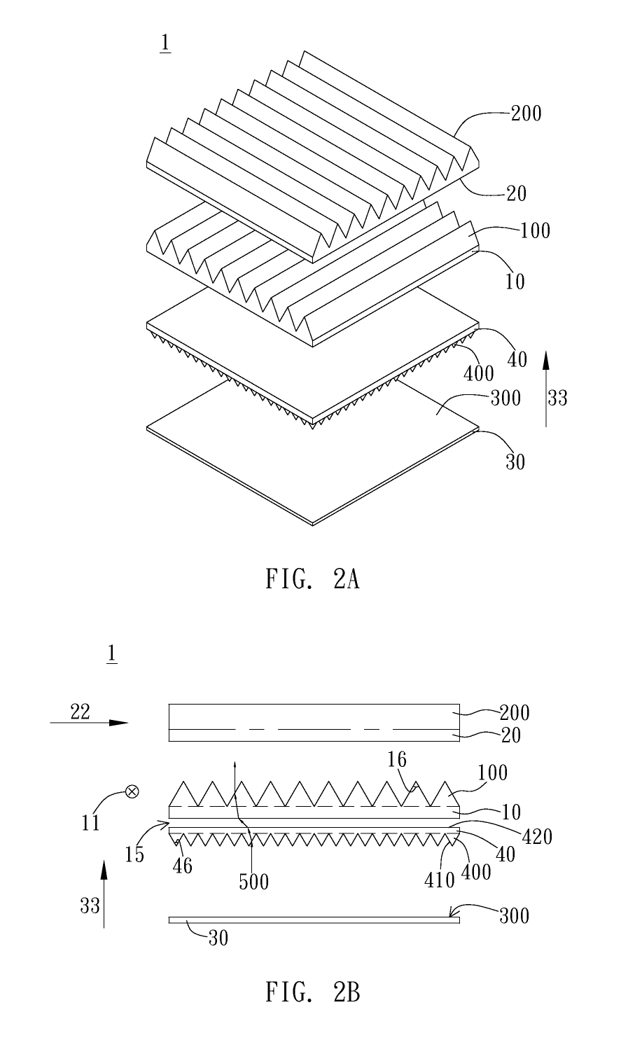

Please refer to FIG. 2A and FIG. 2B, wherein FIG. 2A is a schematic view of the embodiment of the backlight module of the present invention and FIG. 2B is a side view of the embodiment of the backlight module of the present invention. As shown in FIG. 2A, the backlight module 1 includes a light source module 30, an optical structure layer 40, a first prism film 10, and a second prism film 20.

As shown in FIG. 2A, the light source module 30 has a light exit surface 300, wherein the light exit surface 300 has a normal direction 33. In addition, the optical structure layer 40 is disposed on the light exit surface 300 and has a plurality of microstructures 400, which are convex toward the light exit surface 300. In other words, the microstructures 400 face the light exit surface 300. It is noted that adjacent microstructures are closely connected to each other, so that the microstructures 400 are densely distributed on the optical structure layer 40.

In practical applications, the optical structure layer 40 is formed as an independent optical film and disposed between the first prism film 10 and the light source module 30. In other embodiments, the optical structure layer 40 can be formed on the bottom surface of the first prism film 10, but not limited thereto. In addition, the backlight module 1 further has a diffuser (not shown), wherein the diffuser is disposed between the optical structure layer 40 and the light source module 30, but not limited thereto. After the light source module 30 generates light, the light will pass through the optical structure layer 40 and then enters the first prism film 10. In the embodiment, the optical structure layer 40 is not formed as an integral piece with the first prism film 10 in the backlight module 1, but an independent optical film disposed adjacent to the first prism film 10 in the backlight module 1. Particularly, a gap 15 exists between the optical structure layer 40 and the first prism film 10, so that light passing through the optical structure layer 40 will travel in the gap 15 and then enters the first prism film 10.

It is noted that the microstructures 400 can have a quadrangular pyramid shape, a circular convex shape, or other shapes, as appropriate. In the embodiment, the microstructures 400 are formed in a quadrangular pyramid shape with its vertex 46 toward the light exit surface 300. In addition, the vertex 46 has a vertex angle between 50 and 150 degrees.

As shown in FIG. 2A and FIG. 2B, the first prism film 10 is disposed on one side of the optical structure layer 40 opposite to the light source module 30 and has a plurality of first prisms 100 extending along a first direction 11. The vertex 16 of the first prism 100 is in a range between 50 and 130 degrees. In other words, the optical structure layer 40 is formed on the rear side of the first prism film 10 opposite to the first prisms 100. In addition, the pyramid face of each microstructure 400 is rotated 45 degrees with respect to the prism face of the first prism 100. It is noted that the vertex 46 of the microstructure 400 and the vertex 16 of the first prism 100 have a relative relation. In the embodiment, a ratio of vertex angle of the vertex 46 of the microstructure 400 to the vertex 16 of the first prism 100 is between 0.79 and 1.24.

In the embodiment, the microstructures 400 guide light generated from the light exit surface 300 away from the normal direction 33. As shown in FIG. 2B, the light source module 30 generates light 500 and the light 500 is incident onto the microstructure 400 of the optical structure layer 40 along the normal direction 33. It is noted that the light 500 enters the optical structure layer 40 in the forward direction and then refracted at the structure surface 410, wherein the microstructure 400 guides the light 500 generated from the light source 3 away from the normal direction 33. Particularly, the optical structure layer 40 changes the advancing direction of light 500, which is deviated from the normal direction 33, such that the light 500 leaving from the optical face 420 of the optical structure layer 40 has a greater angle relative to the normal direction 33. Consequently, light 500 is incident onto to the first prism film 10 in a non-normal direction (i.e. non-front view angle).

It is noted that when light 500 is incident onto the first prim layer 10 in a non-normal direction (i.e. non-front view angle), the first prisms 100 of the first prism film 10 will converge light 500 that is diverged by the optical structure 40 toward the normal direction 33 on a cross section vertical to the first direction 11. As shown in FIG. 2B, light 500 traveling in the gap 15 is deviated from the normal direction 33, and the first prism film 10 converges the light 500 toward the normal direction 33.

In particular, the backlight module 1 utilizes the optical structure layer 40 to adjust the advancing direction of light 500, such that the light 500 leaving from the optical structure layer 40 is incident onto the first prism film 10 in a direction deviated from the normal direction 33. In addition, since the light 500 enters the first prism film 10 in a non-normal direction, the light 500 will not generate total reflections at the first prism film 10. Furthermore, the optical structure layer 40 utilizes the microstructures 400 to change the advancing direction of light 500, preventing light 500 from generating total reflections at the first prism film 10 so as to improve the light output efficiency and the lighting quality of the backlight module 1.

In addition, the second prism film 20 is disposed on one side of the first prism film 10 opposite to the light source module 30, wherein the second prism film 20 has a plurality of second prisms 200 extending along a second direction 22 that is different from the first direction 11. The second prisms 200 converge light leaving from the first prism film 10 toward the normal direction 33 on a cross section vertical to the second direction 22.

In the embodiment, the first direction 11 is vertical to the second direction 22, but not limited thereto. It is noted that the light passes through the first prisms 100 and the second prisms 200 and is converged toward the normal direction 33 respectively on to the cross section vertical to the first direction 11 and the cross section vertical to the second direction 22, such that the light field of the backlight module 1 can be adjusted.

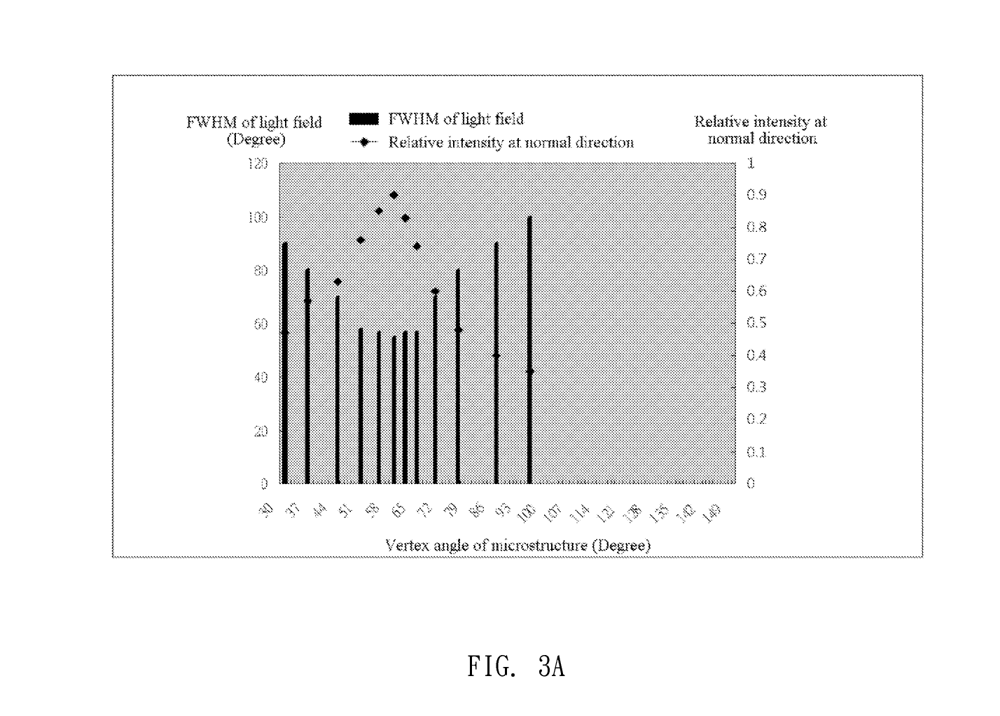

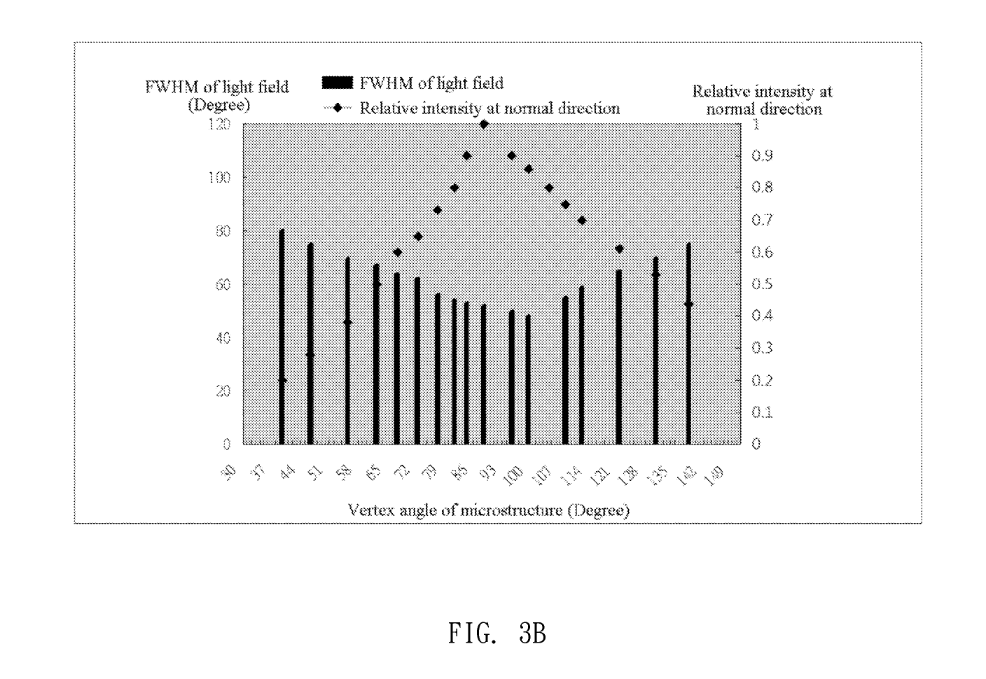

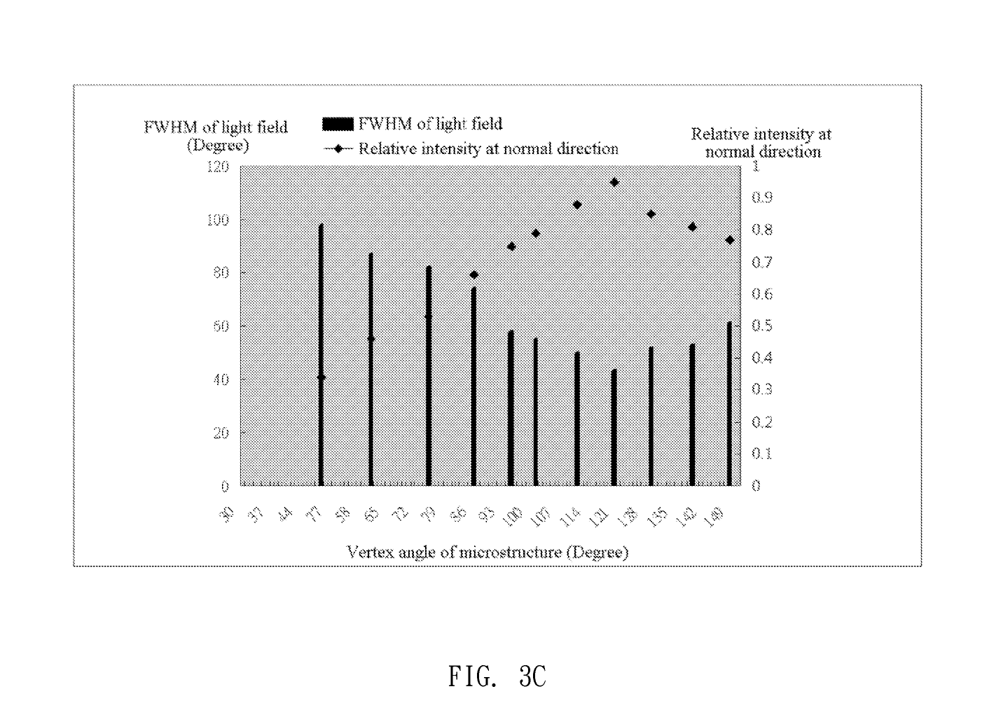

For example, please refer to FIG. 3A, FIG. 3B, and FIG. 3C, which are graphs showing the relative relation among the measured full width at half maximum (FWHM) of the light field, the vertex angle of microstructures, and the relative intensity at normal direction of the backlight module of the present invention. It is noted that the full width at half maximum is the extent covered from the maximum brightness to half of the maximum brightness. In other words, FWHM is the width between the top and half of the peak of the light field function. The relative intensity at normal direction (i.e. front view angle) refers to the relative lighting intensity between the backlight module 1 and the conventional backlight module when directly viewing along the normal direction 33. In practical applications, when the FWHM of the light field is smaller than 60 degrees, the relative lighting intensity at normal direction between the backlight module 1 and the conventional backlight module is 0.7 or higher so as to improve the loss of light at larger angle and also maintain the lighting intensity. Examples of the vertex angle of the prism 100 and the vertex angle of the microstructure 400 are given in Table 1.

TABLE 1

| | |
|---|---|
| vertex angle of | vertex angle of first prism (degree) |

| microstructure (degree) | 60 | 90 | 120 |
|---|---|---|---|
| minimum | 51 | 77 | 95 |
| ratio of vertex angle | 0.85 | 0.86 | 0.79 |
| (microstructure/prism) | | | |
| maximum | 66 | 112 | 148 |
| ratio of vertex angle | 1.1 | 1.24 | 1.23 |
| (microstructure/prism) | | | |

Referring to Table 1 and FIG. 3A, in the embodiment, the angle of the vertex 16 of the first prism 100 and the angle of the vertex of the second prism 200 are both 60 degrees. It is noted that in FIG. 3A the vertex 46 of the microstructure 400 of the optical structure layer 40 is distributed in a range between 30 and 100 degrees. As the vertex of the microstructure is in a range between 51 and 66 degrees, a better lighting efficiency will be achieved. In other words, as the vertex 16 of the first prism 100 is substantially 60 degrees, the vertex 46 of the microstructure 400 is preferably between 51 and 66 degrees.

In addition, referring to Table 1 and FIG. 3B, in the embodiment, the angle of the vertex 16 of the first prism 100 and the angle of the vertex of the second prism 200 are both 90 degrees. It is noted that in FIG. 3B the vertex 46 of the microstructure 400 of the optical structure layer 40 is distributed in a range between 35 and 145 degrees. In practical applications, as the vertex of the microstructure is in a range between 77 and 112 degrees, a better lighting efficiency will be achieved. In other words, as the vertex 16 of the first prism 100 is substantially 90 degrees, the vertex 46 of the microstructure 400 is preferably between 77 and 112 degrees.

In addition, referring to Table 1 and FIG. 3C, in the embodiment, the angle of the vertex 16 of the first prism 100 and the angle of the vertex of the second prism 200 are both 120 degrees. It is noted that in FIG. 3C the vertex 46 of the microstructure 400 of the optical structure layer 40 is distributed in a range between 48 and 150 degrees. In practical applications, as the vertex of the microstructure is in a range between 95 and 148 degrees, a better lighting efficiency will be achieved. In other words, as the vertex 16 of the first prism 100 is substantially 120 degrees, the vertex 46 of the microstructure 400 is preferably between 95 and 148 degrees.

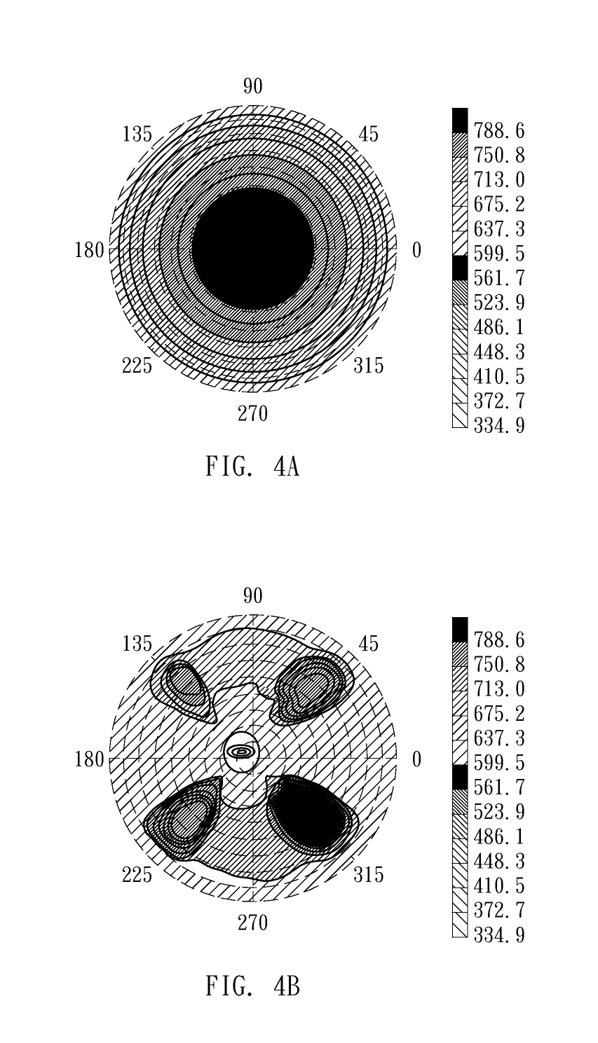

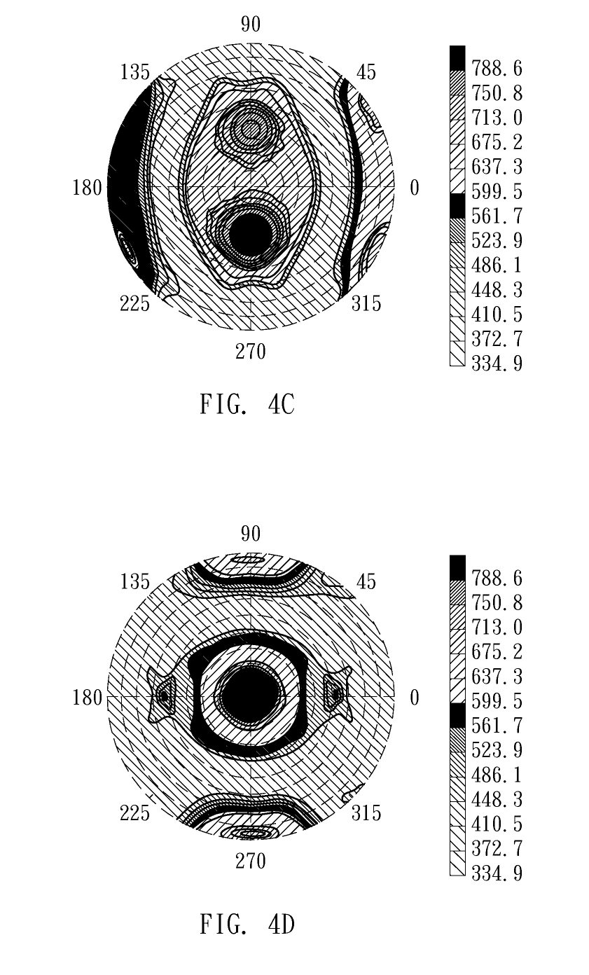

Moreover, if the vertex 16 of the first prism 100 and the vertex of the second prism are both 90 degrees, the light field of three dimensional far field of the backlight module 1 is measured and the results are shown in FIG. 4A, FIG. 4B, FIG. 4C, and FIG. 4D, wherein FIG. 4A is a graph showing the distribution of the first light field of the embodiment of the present invention; FIG. 4B is a graph showing the distribution of the second light field of the embodiment of the present invention; FIG. 4C is a graph showing the distribution of the third light field of the embodiment of the present invention; FIG. 4D is a graph showing the distribution of the fourth light field of the embodiment of the present invention.

It is noted that FIG. 4A is a graph showing the distribution of the first light field that is formed by the light emitted from the light source module 30. In other words, the first light field is formed between the light source module 30 and the optical structure layer 40. In practical applications, when the emission angle is 0 degree, the emission angle is directed toward the normal direction 33 and is the front view angle. When the emission angle is 90 degrees, the emission angle is diverged toward a direction vertical to the normal direction 33. In the first light field, the intensity covering range has an intensity peak at an emission angle between 0 and 30 degrees. The intensity covering range is radially distributed at an azimuth angle between 0 and 360 degrees and uniformly gradually reduced from the emission angle of 0 degree to 90 degrees.

In practical applications, the optical structure layer 40 changes the first light field to form a second light field. Referring to FIG. 4B, in the second light field, the intensity covering range spindle-shaped protrudently extends respectively at azimuth angles between 35 and 55 degrees, between 125 and 145 degrees, between 215 and 235 degrees, and between 305 and 325 degrees and its intensity is gradually reduced toward the center to form an intensity ring. It is noted that the intensity ring generates an intensity peak at the emission angle between 40 and 80 degrees and the FWHM of the intensity peak is 20 degrees. In the embodiment, the intensity ring maintains the intensity peak at azimuth angles of 45, 135, 225, and 315 degrees. In addition, the intensity peak occurs at the emission angle of 47 degrees. In other words, the microstructures 400 adjust the light field to prevent light from being concentrated at the emission angle of 0 degree, so that the intensity peak is distributed at the emission angle between 40 and 80 degrees to improve the light field.

Moreover, the first prism film 10 changes the second light field to form a third light field. Referring to FIG. 4C, in the third light field, the intensity ring is converged toward the normal direction 33 on a cross section vertical to the first direction 11, wherein the first direction 11 is the connecting line between azimuth angles of 90 and 270 degrees. In practical applications, the first prism 100 extends along the first direction 11, so that the intensity ring can be converged toward the normal direction 33 at the cross section vertical to the first direction 11. It is noted that in the third light field, after convergence, a longer side of the intensity ring is parallel to the first direction 11 and an intensity peak occurs at the emission angle between 0 and 50 degrees.

In the embodiment, the intensity peak is concentrated at the azimuth angle between 35 and 55 degrees and the azimuth angle between 125 and 145 degrees, and the intensity peak is concentrated at the azimuth angle between 215 and 235 degrees and the azimuth angle between 305 and 325 degrees, so that the intensity peak of the intensity ring is arranged along the first direction 11 after convergence. It is noted that in the third light field the intensity peak is not distributed at the emission angle between 0 and 20 degrees so as to prevent the light from being concentrated at the normal direction. In addition, in the embodiment, the intensity peak is distributed at the emission angle between 20 and 50 degrees and the FWHM of the intensity peak is 15 degrees, but not limited thereto.

In particular, the second prism 20 changes the third light field to form a fourth light field. As shown in FIG. 4D, in the fourth light field, the second prisms 200 adjust the intensity ring to be converged toward the normal direction 33 on a cross section parallel to the first direction 11. In contrast to the convergence of the third light field toward the normal direction 33 on the cross section vertical to the first direction 11, the fourth light field is converged toward the normal direction 33 on the cross section parallel to the first direction 11, so that the intensity peak is distributed at the emission angle between 0 and 20 degrees. In addition, the intensity covering range is converged at the emission angle between 0 and 40 degrees and rises at an azimuth angle between 90 and 270 degrees and at the emission angle between 60 and 90 degrees. As such, the light field will not be merely concentrated at the front view angle (i.e. the normal direction), providing uniform light output efficiency.

In addition, the present invention illustrates different embodiments by means of microstructures in different shape.

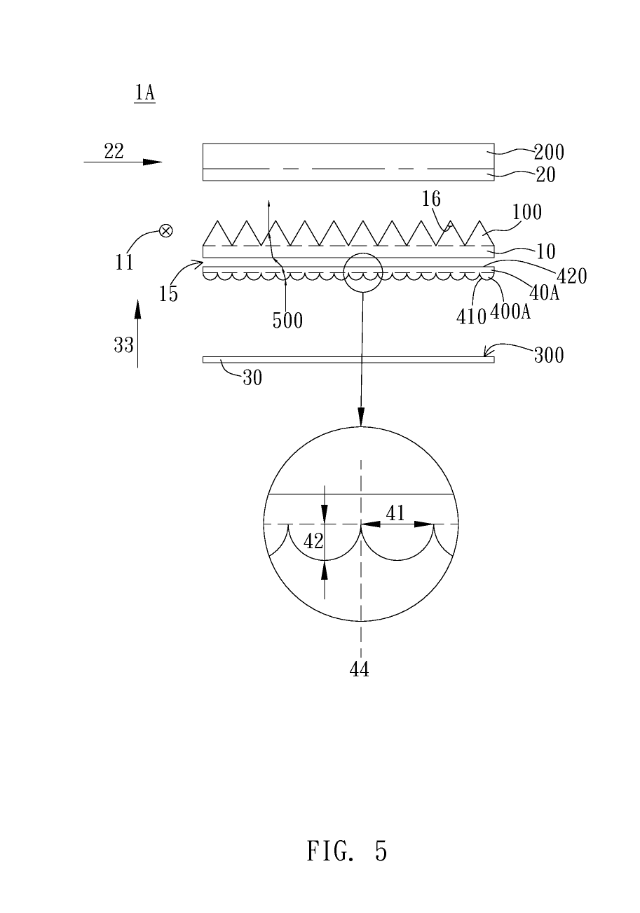

Referring to FIG. 5, FIG. 5 is a schematic view of another embodiment of the backlight module of the present invention. It is noted that in the embodiment the microstructure 400A of the optical structure layer 40 has a circular convex shape. In the embodiment, the microstructures 400A guide the light 500 generated from the light source module 30 away from the normal direction 33, so that the light 500 is not incident onto the first prism film 10 from the normal direction. It is noted that the first prisms 100 of the first prism film 10 converges the light 500 that is diverged by the microstructures 400A toward the normal direction 33 on the cross section vertical to the first direction 11. As shown in FIG. 5, light 500 traveling in the gap 15 is deviated from the normal direction 33, and then the first prism film 10 converges the light 500 toward the normal direction 33. In particular, the optical structure layer 40 utilizes the microstructures 400A to change the advancing direction of the light 500, preventing total reflections of the light 500 at the first prism film 10 to increase the light output efficiency of the backlight module 1A and effectively improve the lighting quality.

In addition, the microstructure 400A has a width 41 and a height 42; the aspect ratio of width 41 to height 42 is relatively high. It is noted that adjacent microstructures 400A have a tangent line 44, wherein the tangent line 44 is parallel to the normal direction 33.

In practical applications, examples of the vertex angle of the first prism 100 and the aspect ratio of the microstructure 400A are given in Table 2.

TABLE 2

| | vertex angle of first prism (degree) | | |
|---|---|---|---|
| aspect ratio of microstructure | 60 | 90 | 120 |
| minimum | 0.5 | 0.8 | 1.6 |
| ratio (aspect ratio of | 0.87 | 0.8 | 0.92 |
| microstructure/half tangent of | | | |
| vertex angle of prism) | | | |
| maximum | 0.8 | 1.6 | 3 |
| ratio (aspect ratio of | 1.39 | 1.6 | 1.73 |
| microstructure/half tangent of | | | |
| vertex angle of prism) | | | |

As shown in Table 2, the ratio of the aspect ratio of the microstructure 400A to the half tangent of vertex angle of the first prism 100 is between 0.87 and 1.73. It is noted that since some vertex angles of the first prisms 100 are larger than 90 degrees, for calculation convenience, the calculation is based on the value of half vertex angle. In practical applications, when the vertex 16 of the first prism 100 is substantially 60 degrees, the aspect ratio of the microstructure 400A is between 0.5 and 0.8. In addition, when the vertex 16 of the first prism 100 is substantially 90 degrees, the aspect ratio of the microstructure 400A is between 0.8 and 1.6. When the vertex 16 of the first prism 100 is substantially 120 degrees, the aspect ratio of the microstructure 400A is between 1.6 and 3. In other words, the shape of the microstructure 400A and the vertex 16 of the first prism 100 have a corresponding relation.

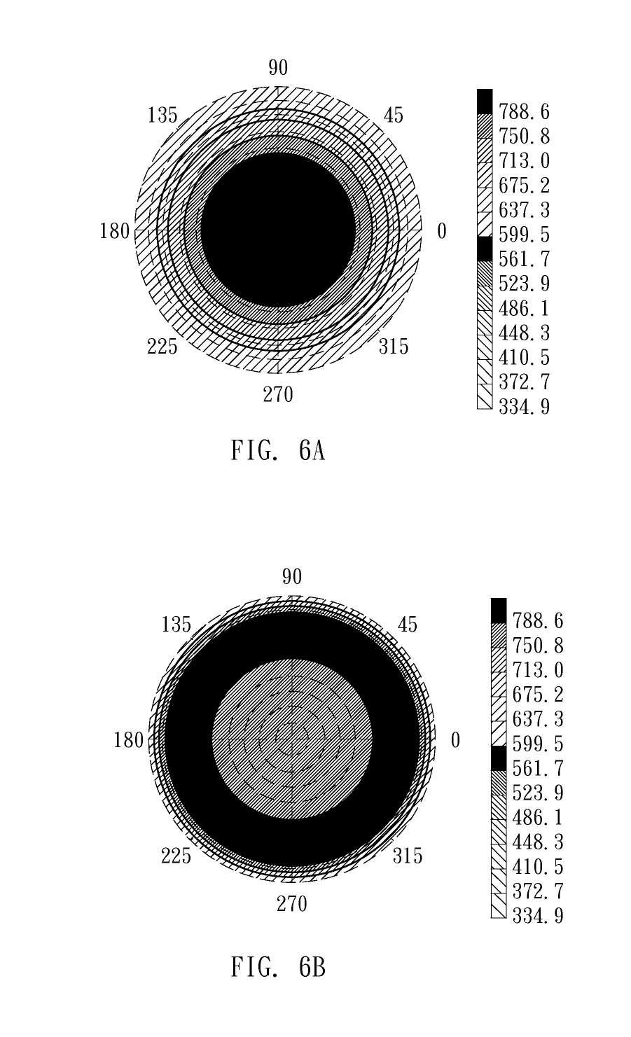

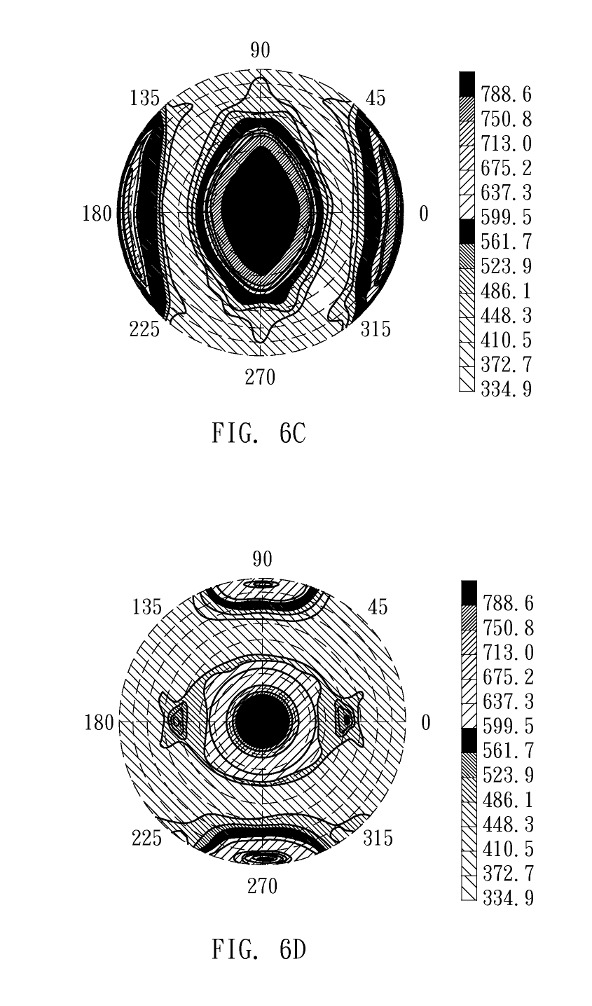

In particular, for example, if the vertex 16 of the first prism 100 and the vertex of the second prism 200 are both 90 degrees, the light filed of three dimensional far field of the backlight module 1A is measured and the results are shown in FIG. 6A, FIG. 6B, FIG. 6C, and FIG. 6D, wherein FIG. 6A is a graph showing the distribution of the first light field of another embodiment of the present invention; FIG. 6B is a graph showing the distribution of the second light field of another embodiment of the present invention; FIG. 6C is a graph showing the distribution of the third light field of another embodiment of the present invention; FIG. 6D is a graph showing the distribution of the fourth light field of another embodiment of the present invention.

It is noted that FIG. 6A is a graph showing the distribution of the first light field that is formed by the light emitted from the light source module 30 and the intensity covering range generated by the first light field. In other words, the first light field is formed between the light source module 30 and the optical structure layer 40.

In practical applications, when the emission angle is 0 degree, the emission angle is directed toward the normal direction 33 and is the front view angle. When the emission angle is 90 degrees, the emission angle is diverged toward a direction vertical to the normal direction 33. In the first light field, the intensity covering range has an intensity peak at an emission angle between 0 and 30 degrees. The intensity covering range is radially distributed at an azimuth angle between 0 and 360 degrees and uniformly gradually reduced from the emission angle of 0 degree to 90 degrees.

In practical applications, the optical structure layer 40 changes the first light field to form a second light field. Referring to FIG. 6B, in the second light field, the intensity covering range protrudently extends outward at azimuth angles between 0 and 360 degrees and its intensity is gradually reduced toward the center to form an intensity ring. It is noted that the intensity ring generates an intensity peak at the emission angle between 40 and 80 degrees and the FWHM of the intensity peak is 20 degrees. In addition, the intensity peak occurs at the emission angle of 47 degrees. In other words, the microstructures 400A adjust the light field to prevent light from being concentrated at emission angle of 0 degree, so that the intensity peak is distributed at the emission angle between 40 and 80 degrees to improve the light field.

Moreover, the first prism film 10 changes the second light field to form a third light field. Referring to FIG. 6C, in the third light field, the intensity ring is converged toward the normal direction 33 on a cross section vertical to the first direction 11, wherein the first direction 11 is the connecting line between azimuth angles of 90 and 270 degrees. In practical applications, the first prism 100 extends along the first direction 11, so that the intensity ring can be converged toward the normal direction 33 at the cross section vertical to the first direction 11. It is noted that in the third light field, after convergence, a longer side of the intensity ring is parallel to the first direction 11 and an intensity peak occurs at an emission angle between 0 and 50 degrees.

In particular, the second prism 20 changes the third light field to form a fourth light field. As shown in FIG. 6D, in the fourth light field, the second prisms 200 adjust the intensity ring to be converged toward the normal direction 33 on a cross section parallel to the first direction 11. In contrast to the convergence of the third light field toward the normal direction 33 on the cross section vertical to the first direction 11, the fourth light field is converged toward the normal direction 33 on the cross section parallel to the first direction 11, so that the intensity peak is distributed at the emission angle between 0 and 20 degrees. In addition, the intensity covering range is converged at the emission angle between 0 and 40 degrees and rises at azimuth angles of 90 and 270 degrees and at the emission angle between 60 and 90 degrees. As such, the light field will not be merely concentrated at the front view angle (i.e. the normal direction), providing uniform light output efficiency.

In comparison with the prior arts, the backlight module of the present invention utilizes the optical structure layer to change the advancing direction of light and in turn to prevent light from entering the first prisms along the normal direction (i.e. front view angle), thus preventing occurrence of total reflections. Furthermore, the backlight module of the present invention utilizes the optical structure layer to adjust the light field so as to change the distribution of light at different emission angle, thus improving the light output efficiency.

Although the preferred embodiments of present invention have been described herein, the above description is merely illustrative. The preferred embodiments disclosed will not limit the scope of the present invention. Further modification of the invention herein disclosed will occur to those skilled in the respective arts and all such modifications are deemed to be within the scope of the invention as defined by the appended claims.

What is claimed is:

1. A backlight module, comprising:
a light source module having a light exit surface, wherein the light exit surface has a normal direction;
an optical structure layer disposed on the light exit surface, wherein the optical structure layer has a plurality of microstructures convex toward the light exit surface; the microstructures guide light generated from the light exit surface away from the normal direction;
a first prism film disposed on one side of the optical structure layer opposite to the light source module, wherein the first prism film has a plurality of first prisms extending along a first direction; the first prisms converge light leaving from the optical structure layer toward the normal direction on a cross section vertical to the first direction; and
a second prism film disposed on one side of the first prism film opposite to the light source module, wherein the second prism film has a plurality of second prisms extending along a second direction different from the first direction; the second prisms converge light leaving from the first prism film toward the normal direction on a cross section vertical to the second direction.

2. The backlight module of claim 1, wherein the optical structure layer is formed as an independent optical film and disposed between the first prism film and the light source module.

3. The backlight module of claim 1, wherein the optical structure layer is formed on a rear side of the first prism film opposite to the first prisms.

4. The backlight module of claim 1, wherein the microstructures are formed in a quadrangular pyramid shape with its vertex toward the light exit surface.

5. The backlight module of claim 4, wherein the adjacent microstructures are closely connected.

6. The backlight module of claim 4, wherein a ratio of vertex angle of the microstructures to the first prisms is between 0.79 and 1.24.

7. The backlight module of claim 6, wherein if the first prisms substantially have a vertex angle of 60 degrees, the microstructures have a vertex angle between 51 degrees and 66 degrees.

8. The backlight module of claim 6, wherein if the first prisms substantially have a vertex angle of 90 degrees, the microstructures have a vertex angle between 77 and 112 degrees.

9. The backlight module of claim 6, wherein if the first prisms substantially have a vertex angle of 120 degrees, the microstructures have a vertex angle between 95 and 148 degrees.

10. The backlight module of claim 1, wherein the microstructures are formed in a circular convex shape.

11. The backlight module of claim 10, wherein a ratio of an aspect ratio of the microstructures to a half tangent of vertex angle of the first prisms is between 0.8 and 1.73.

12. The backlight module of claim 10, wherein if the first prisms substantially have a vertex angle of 60 degrees, the aspect ratio of the microstructures is between 0.5 and 0.8.

13. The backlight module of claim 10, wherein if the first prisms substantially have a vertex angle of 90 degrees, the aspect ratio of the microstructures is between 0.8 and 1.6.

14. The backlight module of claim 10, wherein if the first prisms substantially have a vertex angle of 120 degrees, the aspect ratio of the microstructures is between 1.6 and 3.

15. The backlight module of claim 1, wherein the first direction is vertical to the second direction.

16. A backlight module, comprising:
a light source module having a light exit surface, wherein the light exit surface has a normal direction; the light source module emits light to form a first light field and the first light field generates an intensity covering range;
an optical structure layer disposed on the light exit surface, wherein the optical structure layer changes the first light field to form a second light field; in the second light field, the intensity covering range radially extends outward with intensity gradually reduced toward a center to form an intensity ring;
a first prism film disposed on one side of the optical structure layer opposite to the light source module, wherein the first prism film changes the second light field to form a third light field; in the third light field, the intensity ring is converged toward the normal direction on a cross section vertical to the first direction; and
a second prism film disposed on one side of the first prism film opposite to the light source module, wherein the second prism film changes the third light field to form a fourth light field; in the fourth light field, the intensity ring is converged toward the normal direction on a cross section parallel to the first direction.

17. The backlight module of claim 16, wherein the first prism film has a plurality of first prisms extending along the first direction.

18. The backlight module of claim 16, wherein in the first light field, the intensity covering range has an intensity peak at an emission angle between 0 degree and 30 degrees.

19. The backlight module of claim 16, wherein in the second light field, the intensity ring generates an intensity peak at an emission angle between 40 and 80 degrees and a full width at half maximum (FWHM) of the peak intensity is 20 degrees.

20. The backlight module of claim 16, wherein in the third light field, after convergence, a longer side of the intensity ring is parallel to the first direction and an intensity peak occurs at an emission angle between 0 and 50 degrees.

21. The backlight module of claim 19, wherein in the second light field, the intensity ring protrudently extends respectively at azimuth angles between 35 and 55 degrees, between 125 and 145 degrees, between 215 and 235 degrees, and between 305 and 325 degrees and its intensity is gradually reduced toward the center to form the intensity ring.

22. The backlight module of claim 21, wherein in the third light field, the intensity peaks at azimuth angles between 35 and 55 degrees and between 125 and 145 degrees are concentrated and the intensity peaks between 215 and 235 degrees and between 305 and 325 degrees are concentrated such that after convergence, the intensity peaks of the intensity ring are aligned along the first direction.

23. The backlight module of claim 21, wherein a full width at half maximum of the intensity peak is 15 degrees.

24. The backlight module of claim 16, wherein in the fourth light field, the intensity peak is distributed at an emission angle between 0 and 20 degrees.
